(19) United States
(12) Patent Application Publication
(10) Pub. No.: US 2016/0379106 A1
(43) Pub. Date: Dec. 29, 2016

(54) HUMAN-COMPUTER INTELLIGENCE CHATTING METHOD AND DEVICE BASED ON ARTIFICIAL INTELLIGENCE

(71) Applicant: BAIDU ONLINE NETWORK TECHNOLOGY (BEIJING) CO., LTD., Beijing (CN)

(72) Inventors: Chao Qi, Beijing (CN); Quan Wen, Beijing (CN); Hongliang Chen, Beijing (CN); Xiangyang Zhou, Beijing (CN); Xiaoqing Zhang, Beijing (CN); Zhou Xin, Beijing (CN); Shiqi Zhao, Beijing (CN)

(21) Appl. No.: 14/978,456

(22) Filed: Dec. 22, 2015

(30) Foreign Application Priority Data
Jun. 25, 2015 (CN) 201510359363.9

(51) Int. Cl. G06N 3/00; G06N 99/00

(52) U.S. Cl. CPC G06N 3/006; G06N 99/005

(57) ABSTRACT

The present disclosure provides a human-computer intelligence chatting method and device. The method includes: receiving a multimodal input signal, the multimodal input signal comprising at least one of a speech signal, an image signal, a sensor signal and an event driving signal; processing the multimodal input signal to obtain text data, and obtaining an intention of a user according to the text data; obtaining an answer corresponding to the intention of the user, and converting the answer to a multimodal output signal; and outputting the multimodal output signal.

### CROSS-REFERENCE TO RELATED APPLICATIONS

This application is based on and claims a priority to Chinese Patent Application No. 201510359363.9, filed on Jun. 25, 2015, the entire content of which is incorporated herein by reference.

### FIELD

The present disclosure relates to Internet technology, and more particularly to a human-computer intelligence chatting method and device based on artificial intelligence.

### BACKGROUND

With the constant development of information construction and continuous rising of human service costs, people wish to communicate with computers in nature languages. In this context, the human-computer intelligence chatting system is produced. With the human-computer intelligence chatting system, people may have a chat with the machine in nature languages, and control the machine to accomplish certain operations via the chat, for example, command smart hardware to accomplish message reading and reply, checking weather and flight, and setting alarms and schedules by having a chat with the smart phone, or complete a deep and personal information retrieval and product recommendation by having a chat with the retrieval system.

However, the existing human-computer intelligence chatting system cannot satisfy the chat demand of the user, and cannot have a chat with the user in natural languages.

### SUMMARY

Embodiments of the present disclosure seek to solve at least one of the problems existing in the related art to at least some extent.

Accordingly, a first objective of the present disclosure is to provide a human-computer intelligence chatting method based on artificial intelligence, which may perform an accurate matching with the user's demand and give more accurate and more personal answer during the human-computer chat, thus realizing a more natural chat and satisfying the chat demand of the user.

A second objective of the present disclosure is to provide a human-computer intelligent chatting device based on artificial intelligence.

Accordingly, embodiments of a first aspect of the present disclosure provide a human-computer intelligence chatting method based on artificial intelligence. The method includes: receiving a multimodal input signal, the multimodal input signal comprising at least one of a speech signal, an image signal, a sensor signal and an event driving signal; processing the multimodal input signal to obtain text data, and obtaining an intension of a user according to the text data; obtaining an answer corresponding to the intention of the user, and converting the answer to a multimodal output signal; and outputting the multimodal output signal.

With the method according to embodiments of the present disclosure, during the human-computer dialogue, an accurate matching may be provided for the user's demand and a more accurate and personal reply may be provided to the user, such that the user may have a more natural chat with the machine, thus satisfying the chat demand of the user and improving the user experience.

Accordingly, embodiments of a second aspect of the present disclosure provide a human-computer intelligence chatting device based on artificial intelligence. The device comprises a processor and a memory configured to store instructions executable by the processor, in which the processor is configured to: receive a multimodal input signal, the multimodal input signal comprising at least one of a speech signal, an image signal, a sensor signal and an event driving signal; process the multimodal input signal to obtain text data, and obtain an intension of a user according to the text data; obtain an answer corresponding to the intention of the user, and convert the answer to a multimodal output signal; and output the multimodal output signal.

With the device according to embodiments of the present disclosure, during the human-computer dialogue, an accurate matching may be provided for the user's demand and a more accurate and personal reply may be provided to the user, such that the user may have a more natural chat with the machine, thus satisfying the chat demand of the user and improving the user experience.

Accordingly, embodiments of a third aspect of the present disclosure provide a non-transitory computer-readable storage medium having stored therein instructions that, when executed by a processor of a device, causes the device to perform a human-computer intelligence chatting method based on artificial intelligence, the method comprising: receiving a multimodal input signal, the multimodal input signal comprising at least one of a speech signal, an image signal, a sensor signal and an event driving signal; processing the multimodal input signal to obtain text data, and obtaining an intention of a user according to the text data; obtaining an answer corresponding to the intention of the user, and converting the answer to a multimodal output signal; and outputting the multimodal output signal.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a human-computer intelligence chatting method based on artificial intelligence according to an embodiment of the present disclosure;

FIG. 2 is a schematic diagram showing a system structure used in the human-computer intelligence chatting method according to an embodiment of the present disclosure;

FIG. 3 is a schematic diagram showing a topological structure of the user's intentions according to an embodiment of the present disclosure;

FIG. 4 is a block diagram of a human-computer intelligence chatting device based on artificial intelligence according to an embodiment of the present disclosure;

FIG. 5 is a block diagram of a human-computer intelligence chatting device based on artificial intelligence according to another embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

The present disclosure provides a human-computer intelligence chatting method based on artificial intelligence, which may be deployed on different platforms (including but not limited to internet, mobile phones, smart hardware devices and enterprise customer service platforms), such that a user may have a chat with these platforms via multimodal input signals (including but not limited to speech signals and image signals) which are generally used by the user in common communication with other people.

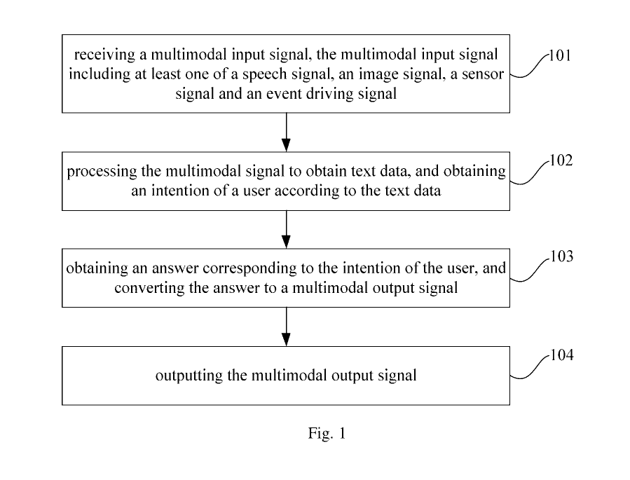

FIG. 1 is a flow chart of a human-computer intelligence chatting method based on artificial intelligence according to an embodiment of the present disclosure. As shown in FIG. 1, the method may include following steps.

In step 101, a multimodal input signal is received, in which the multimodal input signal includes at least one of a speech signal, an image signal, a sensor signal and an event driving signal.

In step 102, the multimodal input signal is processed to obtain text data, and an intention of a user is obtained according to the text data.

Specifically, the text data is analyzed, and the intention of the user is obtained according to a result of analyzing the text data.

The text data may be analyzed as follows. First, a syntactic structure analysis is performed on the text data. Then, a semantic analysis based on words, a domain multi-classification recognition based on a topic model, a semantic disambiguation, and an auto-completion based on grammatical structures and context information are performed.

Further, after obtaining the intention of the user according to the text data, the intention of the user may be stored in historical intentions of the user.

In step 103, an answer corresponding to the intention of the user is obtained, and the answer is converted to a multimodal output signal.

In step 104, the multimodal output signal is outputted.

Specifically, the answer corresponding to the intention of the user may be obtained by following steps: searching a memory system according to the intention of the user, so as to obtain constraint conditions on the intention of the user; searching the topic model and a domain entity database according to the intention of the user, so as to obtain variables and attributes associated with the intention of the user; obtaining a similarity between a current chat context and a pre-stored chat mode via an active learning module; accessing an open service interface, and obtaining a result returned via the open service interface; and obtaining the answer corresponding to the intention of the user according to the intention of the user in combination with the constraint conditions on the intention of the user, the variables and attributes associated with the intention of the user, the result returned via the open service interface and the similarity between the current chat context and the pre-stored chat mode.

Further, the intention of the user, the constraint conditions on the intention of the user, and the variables and attributes associated with the intention of the user may be stored into a dialogue model, and a transition probability map may be established according to a statistical result stored in the dialogue model, such that a new topic may be generated according to the transition probability map at an appropriate time, in which the statistical result is obtained according to the intention of the user, the constraint conditions on the intention of the user, and the variables and attributes associated with the intention of the user.

Further, after obtaining the text data, content favorable for memorizing may be stored in the memory system. The memory system includes a short-term memory system and a long-term memory system. The content favorable for long-term memorizing may be stored in the long-term memory system, and the content favorable for short-term memorizing may be stored in the short-term memory system.

The content favorable for short-term memorizing includes historical dialogue records of the user, a topic status sequence established based on the historical dialogue records and entity-related attributes extracted from the historical dialogue records.

The content favorable for long-term memorizing includes personal information and population attributes of the user, preferences of the user, historical geographic records of the user, historical purchase records of the user, personal information and population attributes in the system and preference of the system.

Further, after obtaining the text data, topics extracted from the text data may be stored in the topic model, and entity attributes extracted from the text data may be stored in the domain entity database.

Specifically, the similarity between the current chat context and the pre-stored chat mode may be obtained by following steps: performing a numeralization on the chat mode of human beings according to the dialogue model, the topic model and the domain entity database, so as to obtain a numerical chat mode; storing the numerical chat mode in the active learning module; and detecting by the active learning module, the similarity between the current chat context and the numerical chat mode.

With the above method, during the human-computer dialogue, an accurate matching may be provided for the user's demand and a more accurate and personal reply may be provided to the user, such that the user may have a more natural chat with the machine, thus satisfying the chat demand of the user and improving the user experience.

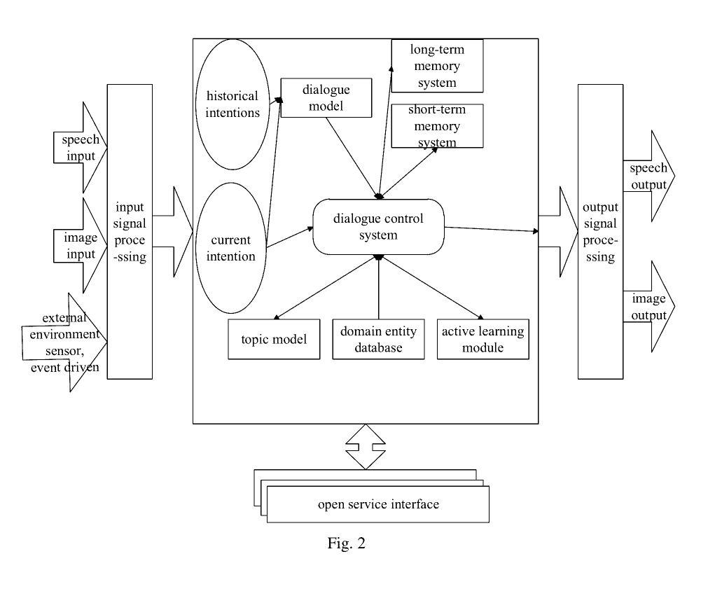

The human-computer intelligence chatting method shown in FIG. 1 may be realized by the system structure shown in FIG. 2. As shown in FIG. 2, different data, components and modules are integrated in the system structure, signal modes acceptable for input and output, data structure used for exchanging data between an input/output system and an internal component and between different internal components, and an order and a relation for exchanging data between different components, may be defined. Moreover, a common data storage device is provided to various components for storing data.

As shown in FIG. 2, following modules and data, including but not limited to, the input/output system, the dialogue model, the dialogue control system, the domain entity database, the topic model, the short-term memory system, the long-term memory system, the active learning module, and the open service interface, may be integrated in the system structure.

In the following, the above modules and data are described in detail respectively.

1. Input/Output System

1) Input Signal

In embodiments of the present disclosure, the input signal may be a multimodal input signal, including at least one of the speech signal, the image signal, the sensor signal and the event driving signal. The sensor signal may include the signal input by the sensor for capturing human related parameters (for example, body temperature and/or heart beat and pulse), and/or the signal input by the sensor for capturing environment parameters (for example, geographic information, temperature, humidity, illumination conditions and/or weather conditions). The event driving signal may include the signal for driving the event which may be actively triggered, for example, event reminder and/or alarm clock.

2) Input Signal Processing

In embodiments of the present disclosure, after receiving the multimodal input signal, the multimodal input signal is processed to obtain text data, and then the intention of the user is obtained according to the text data. Specifically, the text data may be analyzed, and the intention of the user may be generated according to the result of analyzing the text data.

In an embodiment, analyzing the text data may include performing a syntactic structure analysis on the text data, and performing a semantic analysis based on words, a domain multi-classification recognition based on a topic model, a semantic disambiguation, and an auto-completion based on grammatical structures and context information, which will be explained in the following.

a. Syntactic Structure Analysis

For example, for the text data “help me look for flights to Bali Island”, the syntactic structure obtained after analysis is as follows:

```
(ROOT
  (IP
    (NP (NN help me))
    (VP (VV look for)
      (NP
        (DNP
          (NP (NN Bali Island))
          (DEG to))
        (NP (NN flights))))))
```

b. Semantic Analysis Based on Words

For example, for the text data “help me look for flights to Bali Island”, the entity of “Bali Island” and the entity attribute of “flight” may be obtained after performing the syntactic structure analysis on the text data.

c. Domain Multi-Classification Recognition Based on a Topic Model

For example, for the text data “help me look for flights to Bali Island”, topics such as “travel” and “southeast Asia” may be obtained after performing the syntactic structure analysis on the text data

d. Semantic Disambiguation

For example, for the text data “I want to buy an apple”, the semantic disambiguation may be performed on “apple” after performing the syntactic structure analysis on text data, because “apple” here refers to “Apple device”.

e. Auto-Completion Based on Grammatical Structures and Context Information

For example, if the previous search term is “how is the weather in Beijing today?” and the current search term is “is it raining?”, then it may be determined according to the context information and the information in the short-term memory system that, the demand of determining “is it raining?” refers to “Beijing”, and thus the current search term may be completed as “is it raining in Beijing today”.

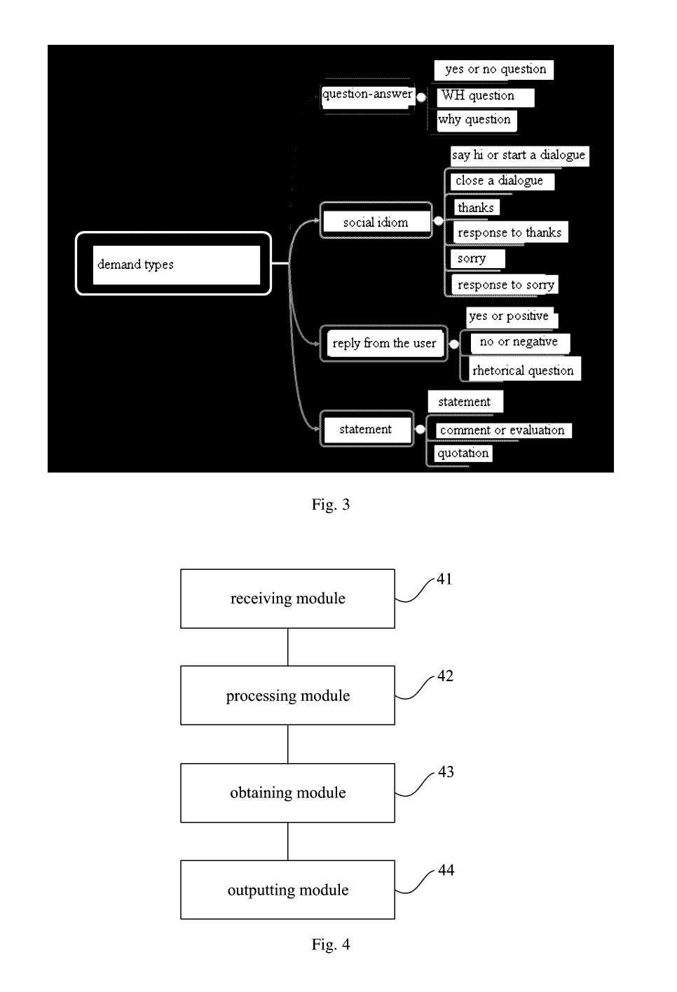

In conclusion, recognizing the user's intention refers to performing a classification based on demand types with respect to the text data obtained, and generating one or more intention representations. In embodiments of the present disclosure, the user's intentions constitute a multi-level topology, as shown in FIG. 3.

3) Output Signal

In embodiments of the present disclosure, the output signal may also be a multimodal output signal, which may include a speech signal and/or an image signal.

The output system converts the answer corresponding to the user's intention to the multimodal output signal via specific hardware devices, and then outputs the multimodal output signal.

2. Dialogue Model and Dialogue Control System

The dialogue model is similar to the working memory area in the human brain, and configured to depict the current intention of the user and variables and constraint conditions associated with the intention.

In embodiments of the present disclosure, the dialogue model may perform a data interaction with several systems, which is described as follows.

1) The current intention of the user is obtained via the input system.

2) Constraint conditions on the intention are obtained via the memory system (including the short-term memory system and the long-term memory system). For example, if the user inputs “how is the weather today”, the location (Beijing Haidian district) where the user often goes may be obtained via the memory system, and then the broad search term may be restrained and completed, for example, the search term is changed to “how is the weather in Beijing Haidian district today”.

3) Variables and attributes associated with the intention are obtained via the topic model and the domain entity database. For example, if the user inputs “what could I do if I don't like my Coach bag”, it may be determined that the current topics include “shopping” and “bag” according to the topic model, and it may be determined that “Coach” is a brand of “bag” according to the domain entity database. Then, based on the above intention analysis and understanding, intelligent recommendation may be obtained, for example, “you may try a different brand, how about Prada”.

In embodiments of the present disclosure, the dialogue model may establish a transition probability map among different intentions based on the statistical result of mass data and may actively generate a new topic according to the above transition probability map at an appropriate time. The appropriate time may include the time when the current topic is over, the time when the user's intention has been satisfied, the time when the user's intention cannot be recognized, and/or the time when there is a confusion about the user's intention.

3. Short-Term Memory System

The short-term memory system is similar to the short-term memory area in the human brain, and configured to store short-term interaction histories. The stored interaction histories may include:

1) several rounds of historical dialogue records between the user and the system;

2) a topic status sequence established based on the historical dialogue records;

For example, the user inputs the following speeches in the past rounds of historical dialogue records:

“how is the weather recently”

“I want to have a travel”

“travel in Bali Island”

“help me look for hotels in Bali Island”

“also look for flights”

Based on the above historical dialogue records, the topic status sequence may be established as “weather”→“travel”→“Bali Island”→“hotel”→“flight”.

3) Entity-Related Attributes Extracted from the Historical Dialogue Records

For example, in the above historical dialogue records, relevant attributes “hotel” and “flight” may be extracted with respect to the entity “Bali Island”. Moreover, based on the entity attribute database, other attributes such as “popular scenic spot” and “entrance ticket” may be recommended.

As time goes on, past memory in the short-term memory system will be automatically removed, and replaced by new memory. The memory clear may be implemented by using a time-dependent exponential decay function.

4. Long-Term Memory System

The long-term memory system is similar to the long-term memory area in the human brain, and may store data including:

1) personal information and population attributes of the user, for example, name, sex and/or residence;

2) preferences of the user, for example, interests and topics depicted by the topic model, and entities and relevant attributes depicted by the domain entity database;

3) historical geographic records of the user, i.e., places where the user goes in the past, which may be obtained via GPS (Global Position System);

4) historical purchase records of the user, i.e., a list of products on which the user paid attention in the past and products which the user bought in the past;

5) personal information and population attributes of the user in the system, i.e. personal information (for example, name, sex and/or residence) returned by the system when the user interact with the system in the past;

6) preferences of the system, i.e. interests, entities and relevant attributes returned by the system when the user interact with the system in the past.

5. Functions of the Memory System and Transformation Between the Long-Term and Short Term Memory System

In embodiments of the present disclosure, the memory system may have the following functions. When analyzing and recognizing the current intention, disambiguation may be performed according to constraint conditions in the memory system, thus further ascertaining the intention of the user. According to the personal information and interests stored in the long-term memory system, personal reply may be returned to the user, thus improving the affinity and intelligence.

Personal information, topics of interest, and preferred entities and attributes included in the short-term memory system may be transformed to long-term memory for storing in the long-term memory system. In addition, when the user has a chat with the system, relevant memory may be extracted from the long-term memory system according to the current demand of the user, the current topic of interest recognized by the topic model, and the entities in the query input by the user, and stored in the short-term memory system, thus facilitating understanding of the user's intention, and limiting the reply of the system.

6. Topic Model and Domain Entity Database

The topic model is used to represent entities, concepts, relations and/or attributes corresponding to topics.

In the topic model, a specific word list may be provided for each topic, and the word list includes entities, concepts, relations and/or attributes related with the topic.

The topic model may classify the text input by the user, and map the text to one or more possible topics.

The domain entity database is configured to store relations and attributes corresponding to the entities, and provide entity related database service.

The entities refer to dependent individualities having definite meanings in nature, including but not limited to:

1) organizations, business units;

2) entertainment products, such as movies, TVs, videos, and songs;

3) commodities;

4) time;

5) geographic locations or areas such as cities and countries;

6) characters;

7) places or buildings with names

For a specific entity, the domain entity database stores the attributes of the entity in nature and values thereof.

The domain entity database may also store relations among different entities, and establish a relation topology of entities based on the relations.

In embodiments of the present disclosure, the domain entity database may provide following database service, including:

query: obtaining the attributes related with the entity according to the entity name, and obtaining other entity names related with the entity according to the entity name, obtaining entities having the same attribute according to an attribute, and a nested combination of above queries;

adding: adding an entity, adding attributes an entity has, and/or adding a relation between two entities;

changing: changing the entity name, changing the attributes corresponding to the entity, and/or changing the relation between two entities;

deleting: deleting attributes corresponding to an entity, deleting the relation between two entities, and/or deleting an entity, attributes the entity has, and the relation between the entity and other entities.

7. Open Service Interface

The open service interface provides a uniform data exchange interface, and connects the system structure shown in FIG. 2 with external services. The external services provide extensional functions for the intelligence chatting system, in which the extensional functions may include:

1) external database service docked with hotels and restaurants, so as to obtain customer data such as orders, and reply to the chat request of the customer; and

2) external service docked with e-business, so as to obtain customer information and order data, provide query result corresponding to the chat request of the customer, and recommend the result and other response.

The functions realized by the open service interface may include:

1) defining the format of data exchange between the system structure shown in FIG. 2 and the external services;

2) automatically and dynamically determining which external services should be accessed for different user requests;

3) automatically and dynamically determining an access sequence in which the multiple external services are accessed;

4) automatically and dynamically determining how to aggregate and filter results of multiple external services.

8. Active Learning Module

The active learning module automatically learns and accumulates the chat mode of human beings according to historical interactions between the user and the intelligence chatting system.

The functions realized by the active learning module may include:

1) performing a numeralization on the chat mode of human being via the dialogue model, the topic model and the domain entity database;

2) storing the numerical chat mode;

3) automatically and dynamically detecting the similarity between the current chat context and the stored chat mode;

4) looking for and returning a most similar response from the stored chat mode according to the current chat context.

The human-computer intelligence chatting method shown in FIG. 1 is based on artificial intelligence (AI for short), which is a new technical science studying and developing theories, methods, techniques and application systems for simulating, extending and expanding human intelligence. The artificial intelligence is a branch of computer science, which attempts to know the essence of intelligence and to produce an intelligent robot capable of acting as a human. The researches in this field include robots, speech recognition, image recognition, natural language processing and expert systems, etc.

The artificial intelligence is a simulation to information process of human consciousness and thinking. The artificial intelligence is not human intelligence, but can think like human and can surpass the human intelligence. The artificial intelligence is a science including wide content, consists of different fields, such as machine learning, computer vision, etc. In conclusion, a main objective of the artificial intelligence is making the machine able to complete some complicated work generally requiring human intelligence.

The human-computer intelligence chatting method shown in FIG. 1 is performed in combination with the memory system and topic model, such that historical interests of the user and information related with context may be remembered during dialogue, thus giving more accurate and personal reply. The active learning module may learn the chat mode of the user while having a chat with the user, and apply it to following chats with the user or other users. By precisely classifying the user's demands, a more accurate demand distribution and matching may be performed. By docking with external services via the open service interface, more user demands may be satisfied.

The human-computer intelligence chatting method provided in FIG. 1 may be applied in various scenarios, for example:

1. local services, for example, reception service in hotels and restaurants, intelligent interaction service on Automatic Teller Machine and/or intelligent guide services in museums;

2. smart hardware devices, for example, personal intelligence assistants and/or intelligent interactive toys;

3. e-commerce, for example, online sales and/or intelligent customer service;

4. travel services, for example, intelligent interactive services for booking flight tickets and hotels.

FIG. 4 is a block diagram of a human-computer intelligence chatting device based on artificial intelligence according to an embodiment of the present disclosure. The device shown in FIG. 4 may be configured as a terminal device or as a part of a terminal device for realizing the procedure shown in FIG. 1. As shown in FIG. 4, the device may include a receiving module 41, a processing module 42, an obtaining module 43 and an outputting module 44.

The receiving module 41 is configured to receive a multimodal input signal, the multimodal input signal including at least one of a speech signal, an image signal, a sensor signal and an event driving signal.

The processing module 42 is configured to process the multimodal input signal to obtain text data.

The obtaining module 43 is configured to obtain an intention of a user according to the text data, and to obtain an answer corresponding to the intention of the user. Specifically, the obtaining module 43 may be configured to analyze the text data and to obtain the intention of the user according to a result of analyzing the text data.

More specifically, the obtaining module 43 may be configured to perform a syntactic structure analysis on the text data, and perform a semantic analysis based on words, a domain multi-classification recognition based on a topic model, a semantic disambiguation, and an auto-completion based on grammatical structures and context information.

The outputting module 44 is configured to convert the answer to a multimodal output signal, and to output the multimodal output signal.

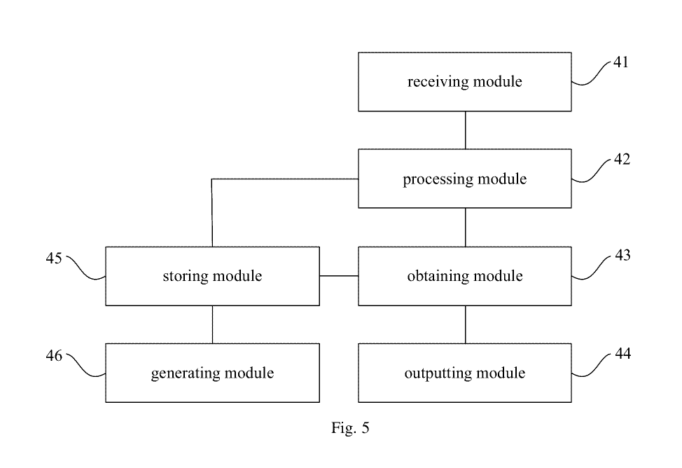

FIG. 5 is a block diagram of a human-computer intelligence chatting device based on artificial intelligence according to an embodiment of the present disclosure. Based on the device shown in FIG. 4, the device shown in FIG. 5 further includes a storing module 45.

The storing module 45 is configured to store the intention of the user into historical intentions of the user.

In embodiments of the present disclosure, the obtaining module 43 is specifically configured to: search a memory system according to the intention of the user, so as to obtain constraint conditions on the intention of the user; search a topic model and a domain entity database according to the intention of the user, so as to obtain variables and attributes associated with the intention of the user; obtain a similarity between a current chat context and a pre-stored chat mode via the active learning module; access an open service interface and obtain a result returned via the open service interface; and obtain the answer corresponding to the intention of the user according to the intention of the user in combination with the constraint conditions on the intention of the user, the variables and attributes associated with the intention of the user, the result returned via the open service interface and the similarity between the current chat context and the pre-stored chat mode.

Further, the device may further include a generating module 46.

The storing module 45 is configured to store the intention of the user, the constraint conditions on the intention of the user, and the variables and attributes associated with the intention of the user into a dialogue model.

The generating module 46 is configured to establish a transition probability map according to a statistical result stored in the dialogue model, and generate a new topic according to the transition probability map at an appropriate time, in which the statistical result is obtained according to the intention of the user, the constraint conditions on the intention of the user, and the variables and attributes associated with the intention of the user.

In embodiments of the present disclosure, the storing module 45 is further configured to store content favorable for memorizing into the memory system after the processing module 42 obtains the text data. The memory system includes a short-term memory system and a long-term memory system. Then, the storing module 45 is specifically configured to store context favorable for long-term memorizing into the long-term memory system and store context favorable for short-term memorizing into the short-term memory system.

The content favorable for short-term memorizing includes historical dialogue records of the user, a topic status sequence established based on the historical dialogue records and entity-related attributes extracted from the historical dialogue records.

The content favorable for long-term memorizing comprises personal information and population attributes of the user, preferences of the user, historical geographic records of the user, historical purchase records of the user, personal information and population attributes in the system and preferences of the system.

In embodiments of the present disclosure, the storing module 45 is further configured to record topics extracted from the text data in the topic model, and record entity attributes extracted from the text data in the domain entity database after the obtaining module 42 obtains the text data.

In embodiments of the present disclosure, the obtaining module 43 is specifically configured to perform a numeralization on the chat mode of human beings according to the dialogue model, the topic model and the domain entity database, so as to obtain a numerical chat mode; store the numerical chat mode in the active learning module; and obtain the similarity between the current chat context and the numerical chat mode from the active learning module.

With the above device, during the human-computer dialogue, an accurate matching may be provided for the user's demand and a more accurate and personal reply may be provided to the user, such that the user may have a more natural chat with the machine, thus satisfying the chat demand of the user and improving the user experience.

In embodiments of the present disclosure, there is also provided a non-transitory computer-readable storage medium stored therein instructions that, when executed by a processor of a device, causes the device to perform the above-described methods.

It should be noted that, in the description of the present disclosure, terms such as “first” and “second” are used herein for purposes of description and are not intended to indicate or imply relative importance or significance. Furthermore, in the description of the present disclosure, “a plurality of” refers to two or more unless otherwise specified.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which the functions may be executed in other orders instead of the order illustrated or discussed, including in a basically simultaneous manner or in a reverse order, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A human-computer intelligence chatting method based on artificial intelligence, comprising:
receiving a multimodal input signal, the multimodal input signal comprising at least one of a speech signal, an image signal, a sensor signal and an event driving signal;
processing the multimodal input signal to obtain text data, and obtaining an intention of a user according to the text data;
obtaining an answer corresponding to the intention of the user, and converting the answer to a multimodal output signal; and
outputting the multimodal output signal.

2. The method according to claim 1, wherein obtaining an intention of a user according to the text data comprises:
analyzing the text data and generating the intention of the user according to a result of analyzing the text data.

3. The method according to claim 2, wherein analyzing the text data comprises:
performing a syntactic structure analysis on the text data, and performing a semantic analysis based on words, a domain multi-classification recognition based on a topic model, a semantic disambiguation, and an auto-completion based on grammatical structures and context information.

4. The method according to claim 1, further comprising:
storing the intention of the user into historical intentions of the user.

5. The method according to claim 1, wherein obtaining an answer corresponding to the intention of the user comprises:
searching a memory system according to the intention of the user, so as to obtain constraint conditions on the intention of the user;
searching a topic model and a domain entity database according to the intention of the user, so as to obtain variables and attributes associated with the intention of the user;
obtaining a similarity between a current chat context and a pre-stored chat mode via an active learning module;
accessing an open service interface, and obtaining a result returned via the open service interface; and
obtaining the answer corresponding to the intention of the user according to the intention of the user in combination with the constraint conditions on the intention of the user, the variables and attributes associated with the intention of the user, the result returned via the open service interface and the similarity between the current chat context and the pre-stored chat mode.

6. The method according to claim 5, further comprising:
storing the intention of the user, the constraint conditions on the intention of the user, and the variables and attributes associated with the intention of the user into a dialogue model;
establishing a transition probability map according to a statistical result stored in the dialogue model, and generating a new topic according to the transition probability map at an appropriate time, wherein the statistical result is obtained according to the intention of the user, the constraint conditions on the intention of the user, and the variables and attributes associated with the intention of the user.

7. The method according to claim 5, after processing the multimodal input signal to obtain text data, further comprising:
storing content favorable for memorizing into the memory system after obtaining the text data.

8. The method according to claim 7, wherein the memory system comprises a short-term memory system and a long-term memory system;
storing content favorable for memorizing into the memory system comprises:
storing content favorable for short-term memorizing into the short-term memory system, in which the content favorable for short-term memorizing comprises historical dialogue records of the user, a topic status sequence established based on the historical dialogue records and entity-related attributes extracted from the historical dialogue records; and
storing content favorable for long-term memorizing into the long-term memory system, in which the content favorable for long-term memorizing comprises personal information and population attributes of the user, preferences of the user, historical geographic records of the user, historical purchase records of the user, personal information and population attributes in the system, and preferences of the system.

9. The method according to claim 5, after processing the multimodal input signal to obtain text data, further comprising:
recording topics extracted from the text data in the topic model and recording entity attributes extracted from the text data in the domain entity database.

10. The method according to claim 5, wherein obtaining a similarity between a current chat context and a pre-stored chat mode via an active learning module comprises:
performing a numeralization on the chat mode of human beings according to the dialogue model, the topic model and the domain entity database, so as to obtain a numerical chat mode;
storing the numerical chat mode in the active learning module; and
detecting by the active learning module, the similarity between the current chat context and the numerical chat mode.

11. A human-computer intelligence chatting device based on artificial intelligence, comprising:
a processor; and
a memory, configured to store instructions executable by the processor,
wherein, the processor is configured to:
receive a multimodal input signal, the multimodal input signal comprising at least one of a speech signal, an image signal, a sensor signal and an event driving signal;
process the multimodal input signal to obtain text data, and obtain an intention of a user according to the text data;
obtain an answer corresponding to the intention of the user, and convert the answer to a multimodal output signal; and
output the multimodal output signal.

12. The device according to claim 11, wherein the processor is configured to analyze the text data and generate the intention of the user according to a result of analyzing the text data, in which the processor is specifically configured to perform a syntactic structure analysis on the text data, and perform a semantic analysis based on words, a domain multi-classification recognition based on a topic model, a semantic disambiguation, and an auto-completion based on grammatical structures and context information.

13. The device according to claim 11, wherein the processor is further configured to store the intention of the user into historical intentions of the user.

14. The device according to claim 11, wherein the processor is configured to:
search a memory system according to the intention of the user, so as to obtain constraint conditions on the intention of the user;
search a topic model and a domain entity database according to the intention of the user, so as to obtain variables and attributes associated with the intention of the user;
obtain a similarity between a current chat context and a pre-stored chat mode via the active learning module;
access an open service interface and obtain a result returned via the open service interface; and
obtain the answer corresponding to the intention of the user according to the intention of the user in combination with the constraint conditions on the intention of the user, the variables and attributes associated with the intention of the user, the result returned via the open service interface and the similarity between the current chat context and the pre-stored chat mode.

15. The device according to claim 14, wherein the processor is further configured to:
store the intention of the user, the constraint conditions on the intention of the user, and the variables and attributes associated with the intention of the user into a dialogue model;
establish a transition probability map according to a statistical result stored in the dialogue model, and generate a new topic according to the transition probability map at an appropriate time, wherein the statistical result is obtained according to the intention of the user, the constraint conditions on the intention of the user, and the variables and attributes associated with the intention of the user.

16. The device according to claim 14, wherein the processor is further configured to:
store content favorable for memorizing into the memory system after obtaining the text data.

17. The device according to claim 16, wherein the memory system comprises a short-term memory system and a long-term memory system, and the processor is further configured to store content favorable for short-term memorizing into the short-term memory system, and to store content favorable for long-term memorizing into the long-term memory system, in which the content favorable for short-term memorizing comprises historical dialogue records of the user, a topic status sequence established based on the historical dialogue records and entity-related attributes extracted from the historical dialogue records; and the content favorable for long-term memorizing comprises personal information and population attributes of the user, preferences of the user, historical geographic records of the user, historical purchase records of the user, personal information and population attributes in the system and preferences of the system.

18. The device according to claim 14, wherein the processor is further configured to:
record topics extracted from the text data in the topic model, and record entity attributes extracted from the text data in the domain entity database after obtaining the text data.

19. The device according to claim 14, wherein the processor is configured to:
perform a numeralization on the chat mode of human beings according to the dialogue model, the topic model and the domain entity database, so as to obtain a numerical chat mode;
store the numerical chat mode in the active learning module; and
obtain the similarity between the current chat context and the numerical chat mode from the active learning module.

20. A non-transitory computer-readable storage medium having stored therein instructions that, when executed by a processor of a device, causes the device to perform a human-computer intelligence chatting method based on artificial intelligence, the method comprising:
receiving a multimodal input signal, the multimodal input signal comprising at least one of a speech signal, an image signal, a sensor signal and an event driving signal;
processing the multimodal input signal to obtain text data, and obtaining an intention of a user according to the text data;
obtaining an answer corresponding to the intention of the user, and converting the answer to a multimodal output signal; and
outputting the multimodal output signal.
